(19) United States
(12) Patent Application Publication
(10) Pub. No.: US 2011/0229850 A1
(43) Pub. Date: Sep. 22, 2011

(54) DENTAL COPING AND ASSEMBLY WITH ALIGNING ANTI-ROTATION FEATURE

(76) Inventors: Joseph N. Bretton, Plainfield, NH (US); Andrea Nicolaisen, Nashua, NH (US); John T. De Angelo, Chelmsford, MA (US)

(21) Appl. No.: 12/727,035

(22) Filed: Mar. 18, 2010

(51) Int. Cl. A61C 13/225

(52) U.S. Cl. 433/172

(57) ABSTRACT

An impression cap or other dental coping is designed to removably engage a dental component such as an abutment, implant and/or and analog in an aligned orientation. The coping includes at least one substantially rigid aligning rib that extends from the inner coronal and side surfaces of the coping and removably engages a groove formed in the corresponding surface of the dental component. The coping may also include a substantially flat aligning surface positioned opposite to the aligning rib in the interior of the coping that contacts a corresponding flat surface on the dental component. The aligning rib and optional flat aligning surface facilitate consistent and precise orientation and positioning of the impression cap or other coping on the dental component, prevent rotation between the coping and component, and also provide a tactile and/or visual indication to the user when the coping and component are not properly aligned.

### FIELD OF THE INVENTION

The present invention relates generally to the field of dental components, and more specifically to components used during the process of taking an impression of a patient's mouth to record accurately the position and orientation of an implant site to enable accurate fabrication of restorative components. The inventive components include an impression cap or other coping for use in a pick-up impressioning method and abutments, implants, analogs and other dental components that are designed to removably engage the impression cap.

### BACKGROUND OF THE INVENTION

Dental implants are widely used to replace lost or damaged natural teeth. The insertion of an implant may be accomplished in several stages. First, an implant is positioned in the maxillary or mandibular bone of the patient and allowed to heal for a period of time, during which osseointegration of the implant into the bone occurs. A healing cap may be positioned over the implant during this time. After the healing period of time, the healing cap is removed and an abutment is coupled to the implant. Once the abutment is secured, an impression may be taken to accurately record the position and orientation of the implant site and to provide the information needed to fabricate the restorative components.

One method of taking an impression of an implant site involves the use of an impression or transfer cap. The impression cap is placed on the abutment or implant. Impression material is applied to the site such that the impression material is squeezed around the impression cap and into the implant site and then removed from the patient's mouth. The impression cap remains in the impression material when it is removed, and it is therefore advantageous for the impression cap to engage removably the abutment or implant during the impression-making process. The impression material is used to create a mold of the implant site for use in fabricating the desired replacement components.

During the impression-making process, it is important to orient the impression cap and replacement component consistently on the various dental components. One known impression cap feature that can be provided to assist in orienting the cap on the dental component is a flat surface portion provided on surface of the inner recess of the cap that is designed to align with a flat surface portion on the component. However, in practice, this design may not be sufficient to prevent improper placement of the cap on the component or to prevent rotation between the cap and the component. Accordingly, a design is needed to provide consistent orientation of the cap on the component and prevent undesired rotation between the cap and component.

### SUMMARY OF THE INVENTION

In view of the foregoing, the present invention relates to an impression cap or other dental coping for removably engaging with a dental component such as an abutment, implant and/or and analog in substantially one orientation. The impression cap or other coping is designed with one or more interior alignment features that provide a precision fit of the cap onto the dental component while substantially preventing rotation between the dental component and the impression cap or other coping. The one or more interior alignment features provide improved consistency in orienting the cap and crown (or other replacement component) on the dental component throughout the impression-making and replacement component fabrication processes and substantially prevent rotational movement between the cap and the dental component. The one or more interior alignment features further may provide a tactile and/or visual indication to the user when the cap and component are not properly aligned.

More specifically, the present invention relates to an impression cap or other coping including a substantially rigid aligning rib extending from the inner coronal surface and the coronal portion of the inner side surface of the impression cap or other coping that removably engages a groove formed in the corresponding surface of an abutment, implant, analog or other component facilitate consistent and precise orientation and positioning of the coping on the dental component and to prevent substantially rotation between the coping and the component. The aligning rib may be of sufficient length to provide a visual indication that the coping is improperly positioned when the rib is not engaged with the dental component. The aligning rib further may have sufficient rigidity to withstand excessive force when a user is trying to force incorrect mating between the coping and the dental component.

Optionally, the impression cap or other coping may also include with an interior substantially flat aligning surface positioned substantially opposite to the aligning rib. The flat aligning surface corresponds to a substantially flat surface formed on the exterior surface of the dental component. The impression cap or other coping may also include one or more external alignment features that enable external visual and tactile assistance in aligning the internal alignment surfaces of the cap and the component. The cap may also include one or more chamfered and/or cylindrical surfaces to assist in providing a precision fit of the cap on the component.

A dental coping in accordance with the present invention may include: a body having a frusto-conical exterior surface, an interior recess, a closed coronal end and an open apical end; a frusto-conical inner side surface provided in the interior recess; a substantially flat inner coronal surface provided at the coronal end of the interior recess; and an aligning rib formed as a protrusion on the inner coronal and side surfaces of the coping. The coping may optionally include a substantially flat aligning surface extending longitudinally on the inner side surface of the coping and positioned substantially opposite to the aligning rib within the inner recess. Optionally, the flat aligning surface may be aligned with a coronally extending alignment structure on the exterior surface of the coping.

A dental assembly for use with the dental coping may include a dental component comprising a groove for removably engaging the aligning rib of the coping. When the coping includes a flat aligning surface, the dental component may also include a flat outer surface portion that aligns with the coping's flat aligning surface.

These and other features and advantages of the present invention will become apparent to those skilled in the art from the following detailed description, wherein it is shown and described illustrative embodiments of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### DESCRIPTION OF THE DRAWINGS

FIG. 1 depicts a longitudinal cross-sectional view of an impression cap including an aligning rib in accordance with the present invention.

FIG. 2 depicts a rotated view of the cross-sectional view of impression cap 1, including the aligning rib.

FIG. 3 depicts a 180-degree rotated view of the cross-sectional view of an impression cap including a flat aligning surface.

FIG. 4 depicts a radial cross-section of impression cap 1.

FIGS. 5A-5B depict the exterior of impression cap 1.

FIG. 5C provides a longitudinal cross-sectional view of impression cap 1.

FIGS. 5D and 5E depict additional views of the exterior of impression cap 1, including an aligning tab and raised surface feature.

FIG. 6 provides a longitudinal cross-sectional view of a solid dental component designed to engage with impression cap 1.

FIG. 7 provides a coronal view of dental component 20.

FIGS. 8A and 8B illustrate the positioning of impression cap 1 on dental component 20 in the aligned orientation.

FIGS. 9A and 9B respectively illustrate proper and improper orientation of the impression cap 1 on a dental component 30.

### DESCRIPTION OF THE PREFERRED EMBODIMENT AND METHOD

The present invention will now be described with reference to the accompanying drawings. The accompanying drawings are intended to provide examples of implementations of the present invention, but are not intended to limit the application of the inventive concepts to the illustrated structures. The inventive engagement and alignment features described herein may be implemented in a variety of dental copings, including impression caps, healing caps, burnout copings, and the like, and dental components, such as abutments, implants, analogs, and the like, as would be apparent to one of skill in the art.

The impression caps and other copings designed in accordance with the present invention are intended to enable alignment between the coping and a dental component in only one specific orientation, or, alternatively, a plurality of specific orientations, each referred to hereinafter as an “aligned orientation.” It is understood that manufacturing tolerances may allow for a very small range of positions when the cap or coping is engaged with the dental component, and such manufacturing tolerances are deemed to be incorporated in the “aligned orientation.”

It is also understood that, while the design according to the present invention is described as “preventing” rotation between the impression cap and dental component, manufacturing tolerances may allow for a minimal degree of rotational movement between the impression cap or other coping and the dental component such that rotation between the coping and the component is not prevented absolutely. Thus, the “prevention” of rotation discussed herein is not intended to require absolute prevention of rotation, but instead is intended to take into account such manufacturing tolerances.

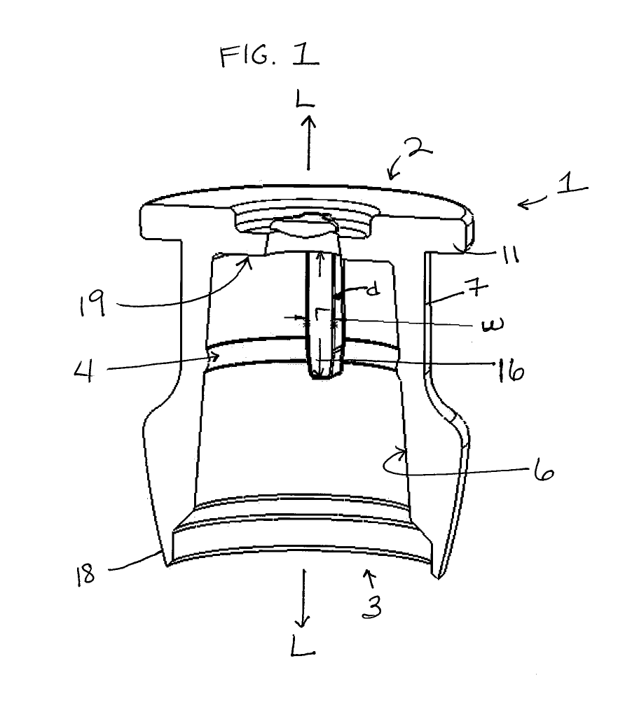

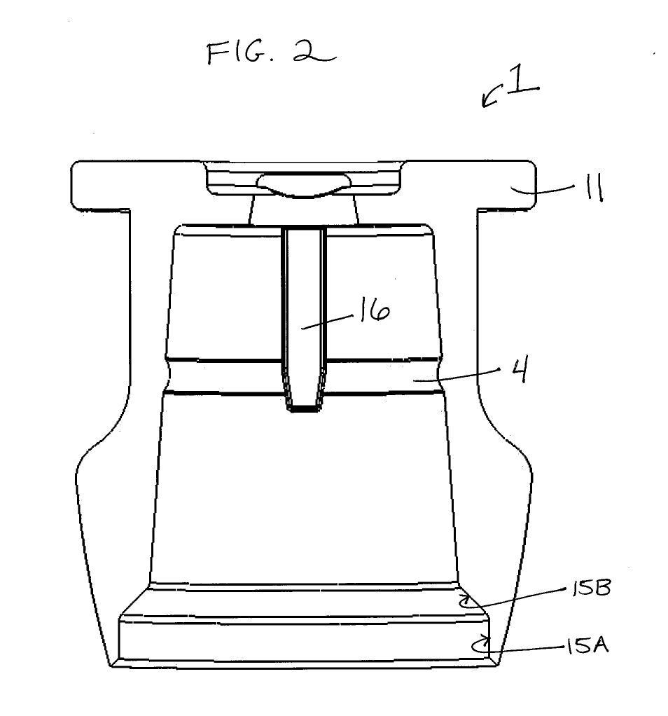

With reference to the accompanying drawings, FIGS. 1 and 2 depict an exemplary impression cap 1 having a coronal end 2, an apical end 3, and a longitudinal axis L. The impression cap 1 forms an interior recess with a frusto-conical inner side surface 6 that is closed at a substantially flat coronal surface 19 at the coronal end 2 of the cap 1 and open at the apical end 3 of the cap 1. The inner side surface 6 of the interior recess of cap 1 is generally frusto-conical in shape, tapering inwardly from the apical end 3 to the coronal end 2 of the cap 1.

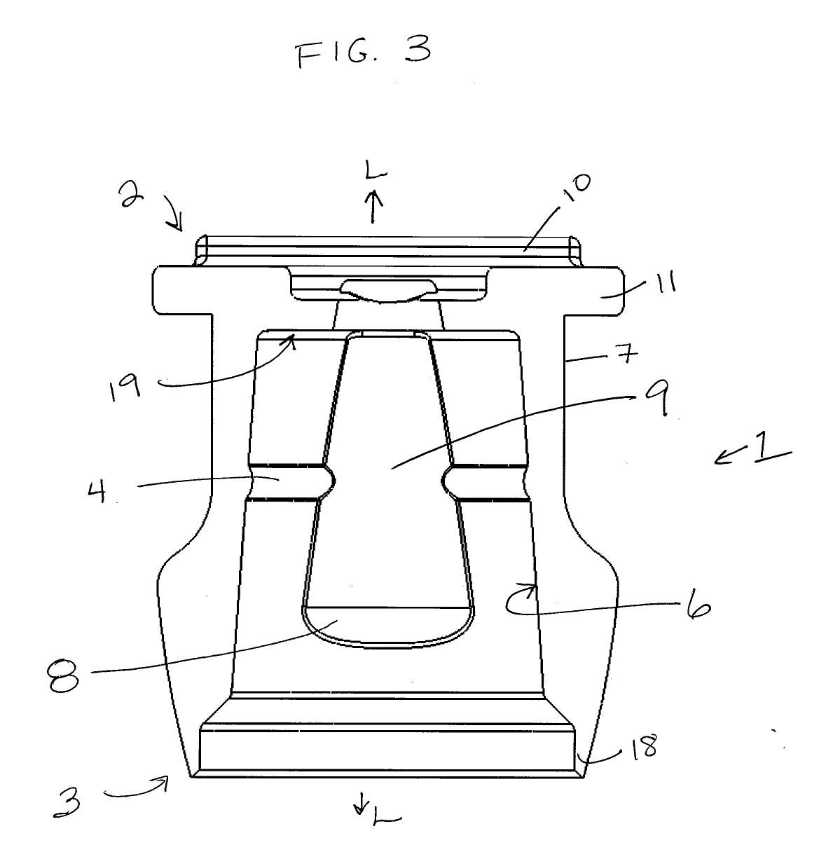

The outer surface 7 of the impression cap 1 may be generally frusto-conical in shape, tapering inwardly from the apical end 3 toward the coronal end 2 of the cap 1. Several structures may be provided on the exterior surface of the cap 1, for example, to assist in orienting the cap 1 on a dental component and/or to facilitate the embedding of the cap 1 in the impression material. Specifically, cap 1 includes a coronally extending alignment tab 10 (see FIG. 3) that extends from the substantially flat coronal surface 17 of the cap 1 to assist with alignment of the cap 1 on a dental component. Cap 1 may further include one or more raised surface features 12 (discussed below with reference to FIGS. 5A-D) provided on the top 17 of the cap to provide a visual cue to assist in alignment of the cap 1 on the dental component. Additionally or alternatively, one or more protrusions, such as circumferential protrusion 11, that extend radially from the outer surface 7 of the cap 1 may be provided to facilitate the embedding of the cap 1 in the impression material. An inwardly tapering portion 18 may be provided at the apical base of the cap 1. A vent 14 may also be provided in the coronal surface 17 of the cap 1 to enable air flow during the impression-making process.

The interior recess of the impression cap 1 is provided with an aligning rib 16 comprising a protrusion that extends apically from the coronal surface 19 and radially inwardly from the inner side surface 6 as illustrated in FIG. 1. The aligning rib 16 is positioned to engage a corresponding groove formed in the surface of a dental component as discussed in detail below with reference to FIGS. 8A and 8B.

Aligning rib 16 may be designed to have dimensions that are sufficient to provide a tactile and/or visual indication that the cap 1 is improperly positioned on a dental component when the aligning rib 16 is not engaged in the corresponding groove of the dental component, such that the cap extends substantially beyond the coronal end of the dental component (as shown in FIG. 9B). For example, in one embodiment of the present invention, the cap 1 may have a overal height of approximately 6-8 mm. Aligning rib 16 may have a length l extending apically from the coronal surface 19 of approximately 2.3 to 2.6 mm and a depth d extending inwardly from the inner side surface 6 of the cap 1 of approximately 0.5 to 0.9 mm. Aligning rib 16 may further be designed with a width w sufficient to provide rigidity such that a user cannot force the cap 1 onto a dental component in any position other than the aligned orientation. For example, in on exemplary embodiment of the present invention in which the cap 1 is fabricated using polypropylene, a width w of approximately 0.4 to 0.5 mm may be appropriate to achieve the desired rigidity of the rib 16. However, aligning rib 16 may be fabricated to have any dimensions sufficient to prevent rotation between the cap 1 and the dental component.

In alternative embodiments, aligning rib 16 may have a different shape or configuration. For example, rib 16 may be designed to be flat, angled and/or curved along its length l, width w, and/or depth d, or may be otherwise shaped (such as U-shaped, triangular, oblong or square) as desired to removably engage the groove in the corresponding dental component while providing sufficient rigidity to prevent improper orientation of the cap on the component as discussed above.

The interior recess of the impression cap 1 may further include an engagement feature 4, which is described in co-pending U.S. patent application Ser. No. 12/337,896, filed on Dec. 18, 2008, entitled “Dental Impression Cap with Engagement Feature,” hereby incorporated by reference in its entirety. Aligning rib 16 may be formed to cross or extend over the engagement feature 4 as illustrated in FIGS. 1 and 2.

As shown in FIG. 2, near the apical end 3 of the cap 1, the inner surface 6 of the cap 1 may further include one or more longitudinally extending engaging surfaces, such as surface 15A, as well as one or more chamfered surfaces, such as surface 15B, to facilitate engagement of the cap with a dental component.

Engagement features such as 4 and surfaces such as 15A and 15B are optional and may be omitted without departing from the scope of the present invention.

With reference to FIG. 3, in one exemplary embodiment of the present invention, substantially opposite the aligning rib 16, the inner side surface 6 of the cap 1 includes a substantially flat aligning surface portion 9 that extends longitudinally and substantially parallel to the longitudinal axis L of the cap 1. The aligning surface portion 9 is centered approximately 180 degrees circumferentially from the aligning rib 16 such that aligning rib 16 is substantially diametrically opposite to aligning surface portion 9. Aligning surface portion 9 may also be designed to align substantially with aligning tab 10 on the exterior coronal surface 17 of the cap 1 to assist visually a user in aligning of the cap 1 on the dental component in the aligned orientation. At the apical end of aligning surface portion 9, a curved surface portion 8 may be provided that connects the apical end of aligning surface portion 9 to the inner side surface 6 of the cap. The positioning of the aligning rib 16 and aligning surface portion 9 in substantially diametrically opposed positions in the inner recess of the cap 1 prevents a user from incorrectly orienting the cap 1 on a dental component, as described in additional detail below with reference to FIGS. 9A and 9B. This embodiment is designed to enable only one aligned orientation of the cap and component.

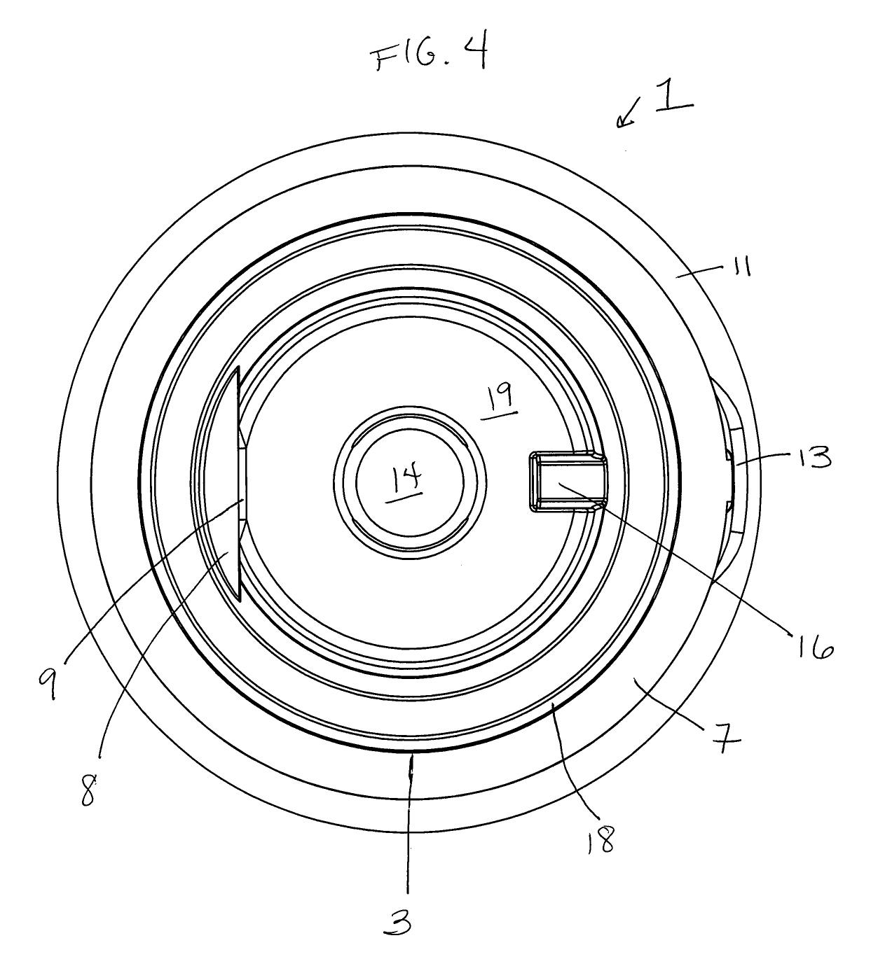

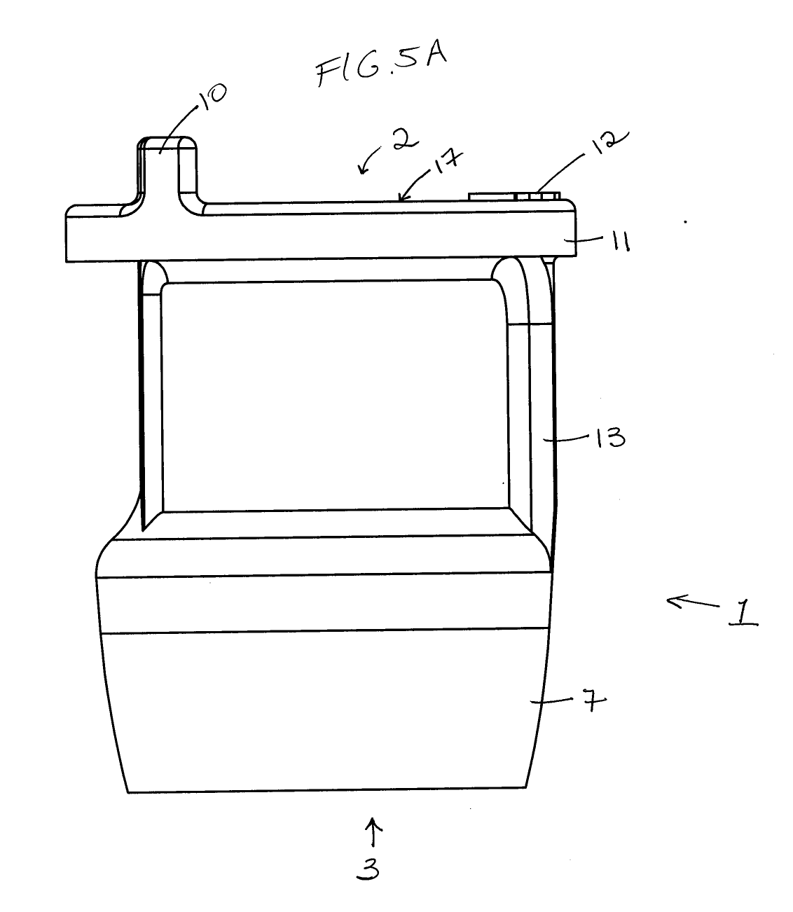

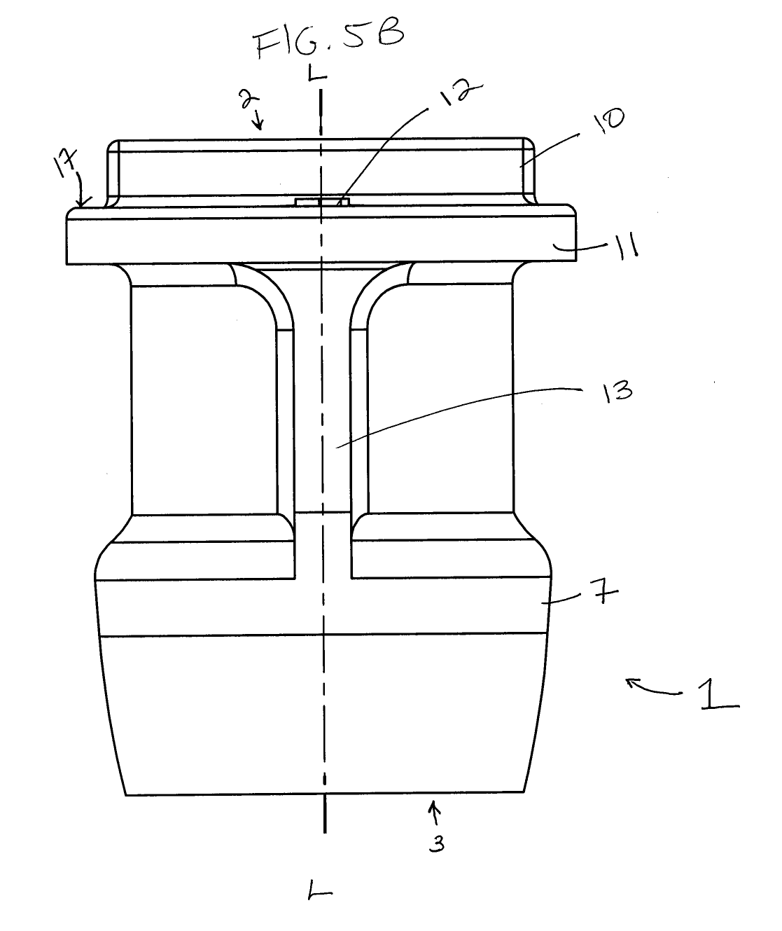

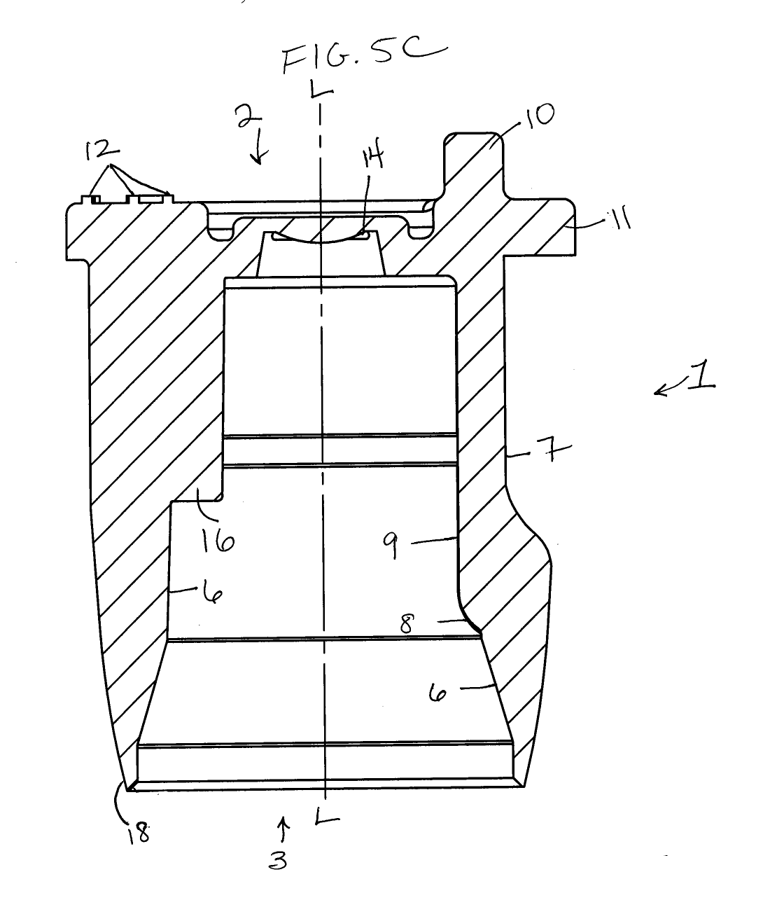

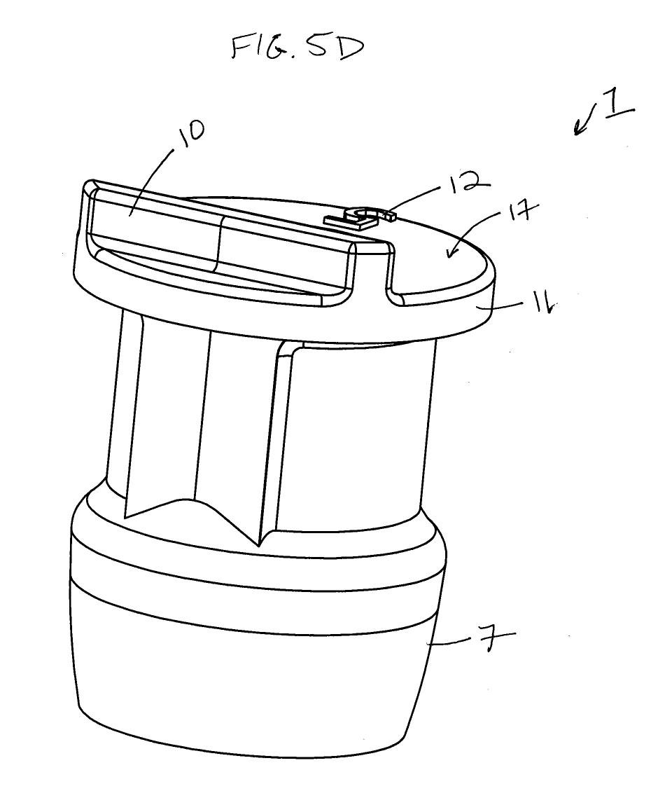

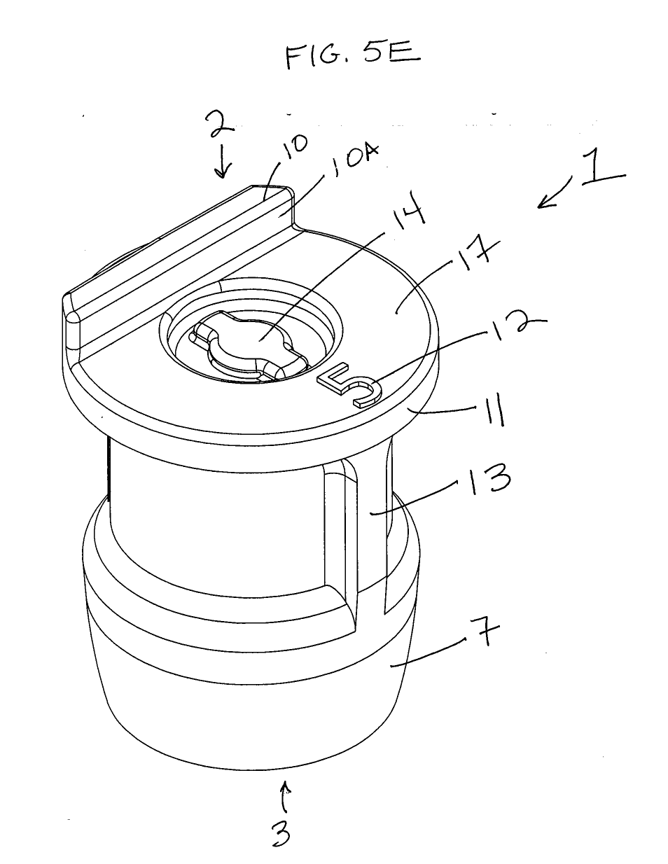

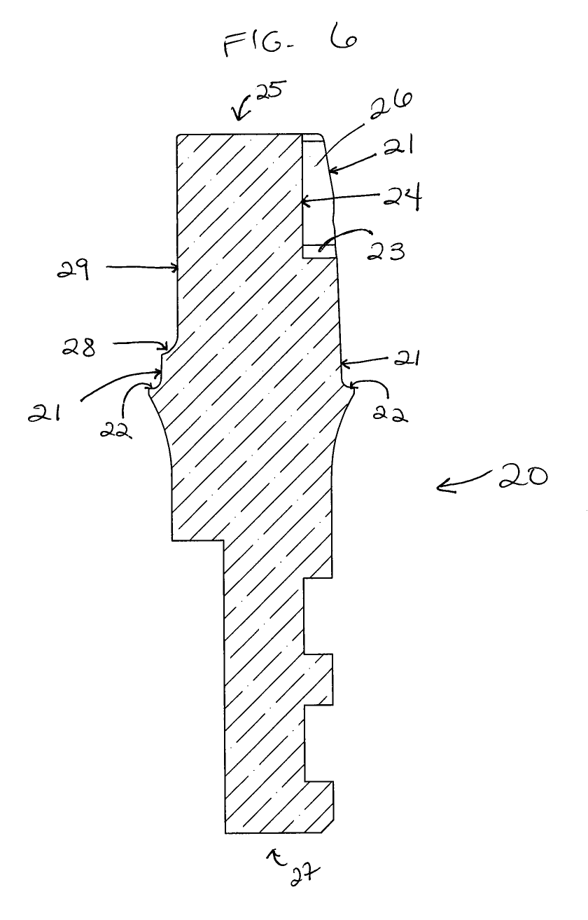

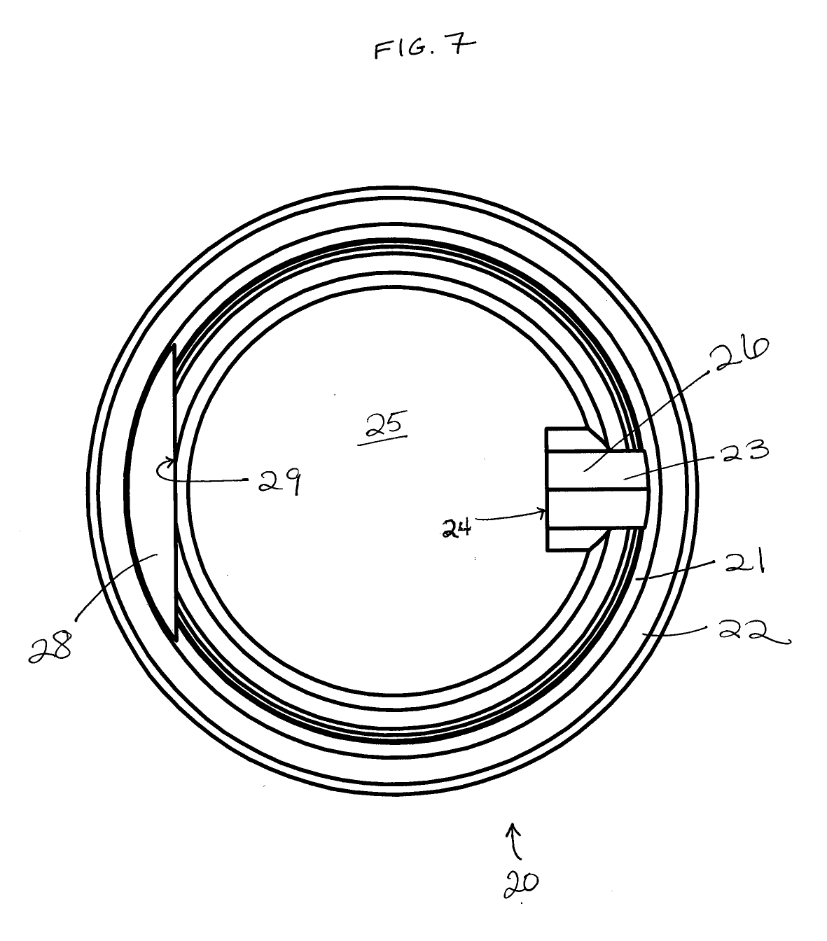

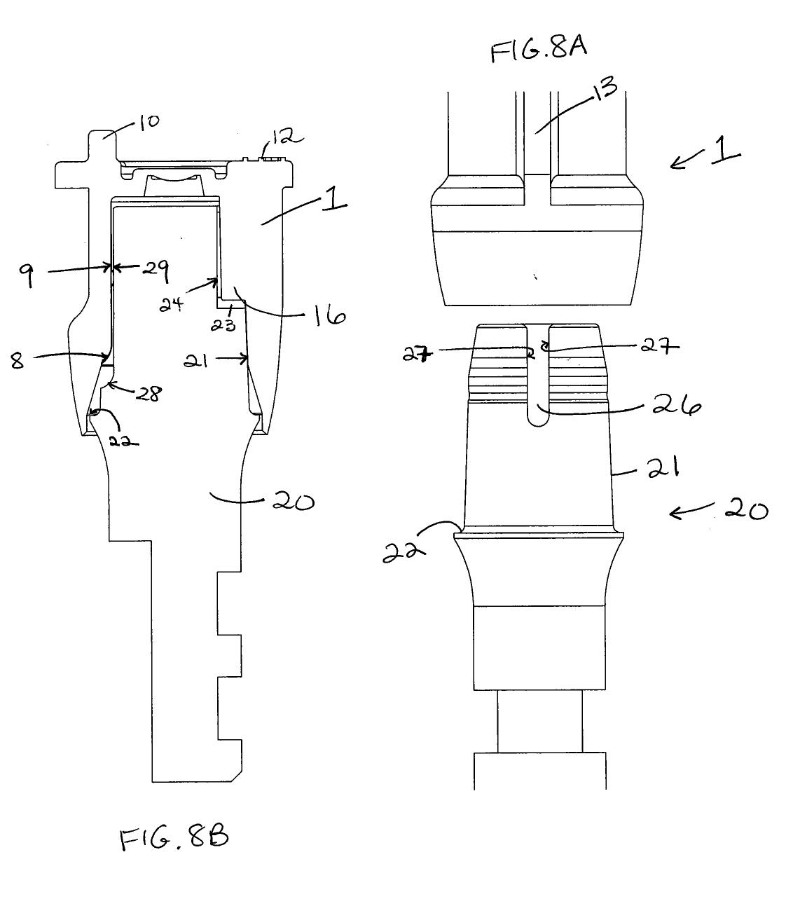

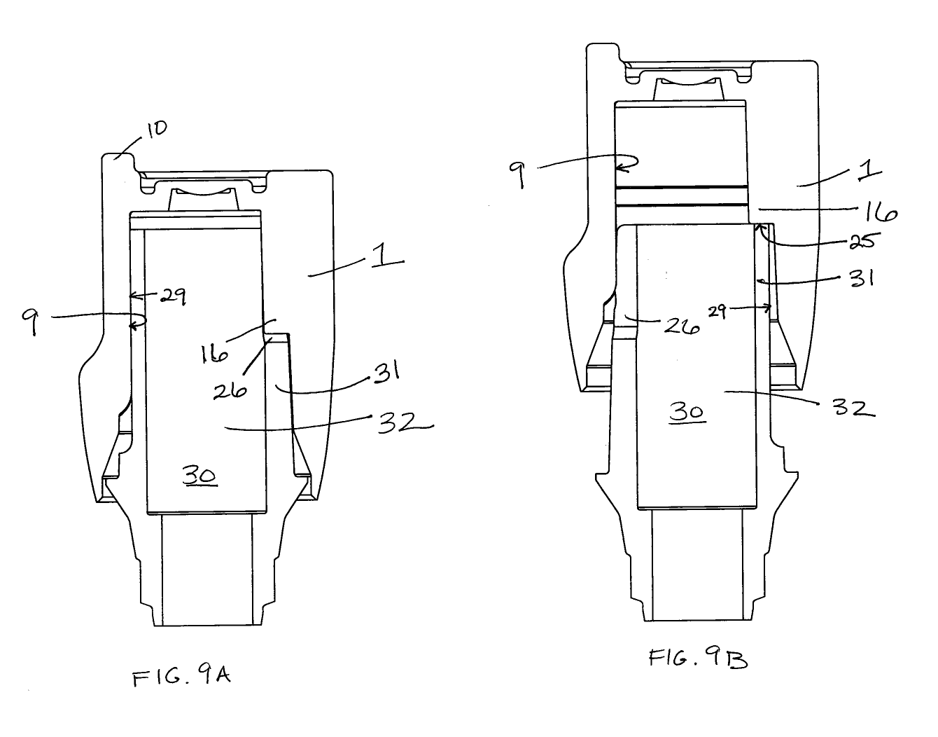

FIG. 4 provides a cross-sectional view of the cap 1 along its longitudinal axis L as seen from the apical end 3 of the cap 1, including inwardly tapering portion 18, outer surface 7, an external support rib 13 (see also FIGS. 5A, 5B, and 5E), and circumferential protrusion 11. Aligning rib 16 and flat aligning surface portion 9 and curved surface portion 8 are illustrated in diametrically opposed positions within the inner recess of the cap 1. Vent 14 is provided in coronal surface 19 of the inner recess of the cap.

FIGS. 5A-5D illustrate various additional views of the impression cap 1. FIG. 5A depicts a side view of the exterior of impression cap 1, including outer surface 7, circumferential protrusion 11, aligning tab 10 and raised surface feature 12 extending from coronal surface 17, and external support rib portion 13.

FIG. 5B depicts a side view of impression cap 1 that is rotated ninety degrees from the view provided in FIG. 5A, including a side view of support rib portion 13, which may be integrally formed or molded as part of the cap 1 during manufacture. Aligning tab 10, raised surface feature 12, and circumferential protrusion 11 are also shown.

FIG. 5C provides a longitudinal cross-sectional view of the impression cap 1 illustrating the alignment of aligning tab 10 on the exterior of the cap 1 with aligning surface portion 9 on the interior of the cap 1. In particular, aligning tab 10 is positioned on coronal surface 17 such that a surface 10A of the tab 10 faces longitudinal axis L of the cap (see FIG. 5E) and runs substantially parallel to the aligning surface portion 9 provided on the inner side surface 6 of the cap. Aligning tab 10 is also positioned coronally above the aligning surface portion 9 in the longitudinal direction on the coronal surface 17 of the cap 1 to provide an external visual indication of the alignment of the aligning surface portion 9 in the interior recess of the cap. Alignment of raised surface feature 12 on the cap's exterior with the aligning rib 16 on the cap's interior is also illustrated. In particular, the raised surface feature 12 is positioned coronally above the aligning rib 16 in the longitudinal direction on the coronal surface 17 of the cap 1 to provide an external visual indication of the position of the aligning tab 16 in the interior recess of the cap. The aligning tab 10 and raised surface feature 12 are provided on substantially diametrically opposed sides of the coronal surface 17 of the cap.

FIGS. 5D and 5E provide three-dimensional illustrations of the impression cap 1 from two different perspectives. FIG. 5D illustrates the aligning tab 10, which is positioned tangentially within the circumference of the circular coronal surface 17 of the cap 1. An exemplary raised surface feature 12 is illustrated in the shape of the number “5.” The raised surface feature 12 may be provided in any desired configuration, such as one or more numbers, letters, symbols, logos, designs, lines, arrows, indentations, printed markings, colors, or other configuration, as an external visual indicator of the location of the aligning rib 16 in the interior of the cap.

FIG. 5E provides an alternative view of the impression cap 1, illustrating the positioning of aligning tab 10, including surface 10A, raised surface feature 12, and vent 14 on coronal surface 17. Support rib portion 13, which is formed on the outer surface 7 of the cap 1, is also shown. In this embodiment, the support rib 13 is positioned diametrically opposite to the center of aligning tab 10 such that its position on the exterior surface 7 of the cap substantially aligns with the position of aligning rib 16 on the interior side surface 6 of the cap.

Impression cap 1, including the alignment features described above, may be manufactured using conventional molding or other fabrication methods using polypropylene, acetal or any other desired material(s).

It is envisioned that healing caps, burnout copings, and other types of dental copings may be provided with an aligning rib, such as aligning rib 16 of cap 1 or a similar aligning structure, and a substantially diametrically opposed flat aligning surface, such as aligning surface 9 of cap 1 or a similar aligning surface, as described herein to enable precise orientation of such caps on temporary or permanent single-part or multi-part abutments, single-part or multi-part implants, analogs or replicas, crowns and/or other dental components.

FIG. 6 provides a longitudinal cross-sectional view of a dental component 20, which is shown as an analog for illustrative purposes, but may comprise any type of implant, abutment, analog, replica or other dental component, that is designed to engage with impression cap 1. Component 20 may be manufactured using a titanium alloy or other material as desired using conventional manufacturing techniques.

Component 20 has a coronal end 25 and an apical end 27. Component 20 includes a generally frustoconical outer surface 21 that extends coronally from circumferential shoulder 22, which is provided to engage the apical base of the cap 1, for example, as shown in FIGS. 8B and 9A.

Component 20 includes a groove 26 formed in the surface 21, such that the groove 26 is adapted to removably engage aligning rib 16 when the cap 1 is in the aligned orientation on the component 20. Since component 20 is a substantially solid dental component in that it does not include a hollow portion proximal to groove 26, groove 26 comprises four surfaces, including a radially extending curved apical surface 23 having a radial depth sufficient to accommodate the depth d of the aligning rib 16 and having a width sufficient to accommodate the width w of the aligning rib 16, a longitudinally extending inner surface 24 having a length sufficient to accommodate the length l of the aligning rib 16 and having a width sufficient to accommodate the width w of the aligning rib 16, and opposing side surfaces 27 of groove 26 have a radial depth sufficient to accommodate the depth d of the aligning rib 16 and a length sufficient to accommodate the length l of the aligning rib 16.

In alternative embodiments, groove 26 may have differing shapes or configurations as needed to accommodate the shape and configuration of the aligning rib 16. For example, the apical surface 23 of the groove 26 may be flat or angled instead of curved, and/or the inner surface 24 and/or side surfaces 27 of the groove 26 may be curved, angled or otherwise shaped as desired to removably accommodate aligning rib 16.

In some instances, the dental component on which the cap 1 is to be positioned is not solid, as described above, but instead is hollow in that it includes a hollow portion proximal to groove 26, such as illustrated by component 30 in FIGS. 9A and 9B (discussed below). When the component is hollow, groove 26 may comprise three surfaces, including the radially extending apical surface 23 and opposing side surfaces 27. When the component is hollow, the groove 26 does not include a longitudinally extending inner surface (e.g., surface 24 in FIG. 8B). In such embodiments, groove 26 may form a slot in the outer surface or wall of the component that can accommodate an aligning rib 16 having a depth d that may extend into the hollow portion of the component when it engages groove 26. The three sides of groove 26 are sufficient to orient the cap 1 on the component 20 in the aligned orientation and prevent rotation between the cap and component.

With reference to FIG. 6, in the circumferentially opposing side of outer surface 21, component 20 comprises a substantially flat aligning surface portion 29 that is adapted to contact aligning surface portion 9 of the cap 1 when the cap is in the aligned orientation on the component. A curved surface portion 28 may also be provided.

FIG. 7 provides a coronal view of solid component 20, including side surface 21, circumferential shoulder portion 22, groove 26 with apical curved surface 23 and inner surface 24, flat aligning surface portion 29 and curved surface portion 28.

FIGS. 8A and 8B illustrate the engagement of solid component 20 and impression cap 1. In FIG. 8A, the impression cap 1 is aligned for proper orientation of the cap on the component 20. The external support rib 13 indicates the location of the aligning rib 16 on the inner side surface 6 of the cap 1. In FIG. 8B, the impression cap 1 is in the aligned orientation on component 20. Aligning rib 16 engages groove 26, aligning surface portion 9 of the cap 1 engages flat aligning surface portion 29 of the component 20, and base of the cap 1 is engaged by circumferential shoulder 22.

FIGS. 9A and 9B respectively illustrate proper and improper orientation of the impression cap 1 on a hollow component 30, which is shown as an abutment for illustrative purposes. Groove 26 in hollow component 30 forms a slot in the outer wall 31 of the component that surrounds hollow region or bore 32. Groove 26 accommodates aligning rib 16 such that aligning rib 16 may extend through wall 31 into the hollow portion 32 of the component 30 when it engages groove 26.

In FIG. 9A, the cap 1 is in the aligned orientation such that aligning rib 16 of the cap 1 engages groove 26 of the component 30 and flat aligning surface portion 9 of the cap 1 contacts flat aligning surface portion 29 on the surface 21 of the component 30. In contrast, in FIG. 9B, the cap 1 is rotated approximately 180 degrees from the aligned orientation, such that the apical surface of the aligning rib 16 contacts the coronal surface 25 of the component 30 instead of engaging the groove 26. As a result of this improper alignment, a substantial portion of the cap 1 extends coronally beyond the coronal surface 25 of the component 30, thereby providing a visual indication that the cap 1 is not positioned correctly on the component 30.

In this manner, the alignment features according to the present invention provide a tactile and/or visual indication when the cap and component are not properly aligned. When the cap and component are not aligned, the user can feel that the cap is not properly seated and can see that the cap extends beyond the coronal end of the component. In contrast, when the cap and component are properly aligned, the cap slides into its proper seating on the component.

As an alternative to the exemplary embodiments of the present invention as described above with reference to FIGS. 1-9B, an impression cap or other dental coping in accordance with the present invention may include only an aligning rib and no flat aligning surface portion. The aligning rib structure by itself can be sufficient to enable orientation of the coping in the aligned position, provide a tactile and/or visual indication when the coping and component are not in the aligned orientation, and substantially prevent rotation between the coping and component.

In another alternative embodiment of the present invention, an impression cap or other coping may be provided with a plurality of aligning ribs, each having substantially the structure of aligning rib 16 described above, and each designed to engage a corresponding groove formed in the dental component on which the coping is to be positioned. Such an embodiment may or may not also include a flat aligning surface portion.

In alternative embodiments in which no flat aligning surface is provided, it is envisioned that a dental component may be provided with a plurality of grooves, each adapted to engage one or more aligning ribs, such that the “aligned orientation” may comprise a plurality of aligned orientations in which the one or more aligning ribs are engaged in one or more of the plurality of grooves in the component.

For example, when an impression cap has one aligning rib and no flat aligning surface portion, a corresponding dental component may be provided with a plurality of grooves, any one of which can engage the aligning rib. In such an embodiment, the “aligned orientation” includes a plurality of aligned orientations, one for each groove into which the aligning rib can be inserted.

Alternatively, when an impression cap is provided with a plurality of aligning ribs and no flat aligning surface, a corresponding dental component includes at least one groove corresponding to each aligning rib. The aligning ribs on the cap and grooves of the component may be positioned to enable multiple aligned orientations of the cap on the component (for example, when the aligning ribs and grooves are positioned at regular intervals around the circumference of the cap and component respectively) or to enable only one aligned orientation of the cap on the component (for example, when the aligning ribs and grooves are positioned irregularly such that only one alignment is possible).

From the above description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. References to details of particular embodiments are not intended to limit the scope of the invention. Accordingly, it is intended that the scope of the present invention be dictated by the appended claims rather than by the description of the preferred embodiment.

Claimed is:

1. A dental coping for removable engagement with a dental component extending from gingival tissue, comprising:
a body having a coronally extending frusto-conical exterior surface, an interior recess, a closed coronal end and an open apical end, wherein the interior recess comprises a frusto-conical inner surface extending coronally from the apical end and a substantially flat coronal surface at the closed coronal end of the body; and
an aligning rib extending from the coronal surface and the inner surface of the interior recess, wherein the aligning rib extends apically from the coronal surface and inwardly from a coronal portion of the inner surface, and wherein the aligning rib is designed to engage a corresponding groove formed in a coronal portion of the dental component to enable seating of the coping on the dental component in an aligned orientation and to prevent substantially rotation of the coping with respect to the component,
wherein the aligning rib is sufficiently rigid to prevent seating of the coping on the dental component in an orientation other than the aligned orientation and to provide a visual indication when the coping is not seated on the dental component in the aligned orientation.

2. The dental coping of claim 1, further comprising a flat alignment surface formed on the inner surface of the interior recess, wherein the flat alignment surface is designed to align with a corresponding flat surface provided on a dental component.

3. The dental coping of claim 2, wherein the aligning rib is provided substantially opposite the flat alignment surface on the inner surface of the inner recess.

4. The dental coping of claim 1, further comprising at least one additional aligning rib extending from the coronal surface and the inner surface of the interior recess and designed to engage a corresponding additional groove formed in the coronal portion of the dental component to enable seating of the coping on the dental component in the aligned orientation.

5. The dental coping of claim 1, wherein the coping further includes an engagement feature that enables the coping to snap fit onto the dental component.

6. A dental coping for removable engagement with a dental component extending from gingival tissue, comprising:
a body having a coronally extending frusto-conical exterior surface, an interior recess, a closed coronal end and an open apical end, wherein the interior recess comprises a frusto-conical inner surface extending coronally from the apical end and a substantially flat coronal surface at the closed coronal end of the body;
a flat alignment surface formed on the inner surface of the interior recess, wherein the flat alignment surface is designed to align with a corresponding flat surface provided on a dental component; and
an aligning rib extending from the coronal surface and the inner surface of the interior recess, wherein the aligning rib is provided substantially opposite the flat alignment surface on the inner surface of the inner recess, wherein the aligning rib extends apically from the coronal surface and inwardly from a coronal portion of the inner surface, and wherein the aligning rib is designed to engage a corresponding groove formed in a coronal portion of the dental component to enable seating of the coping on the dental component in an aligned orientation and to prevent substantially rotation of the coping with respect to the component,
wherein the aligning rib is sufficiently rigid to prevent seating of the coping on the dental component in an orientation other than the aligned orientation and to provide a visual indication when the coping is not seated on the dental component in the aligned orientation.

7. A dental assembly, comprising:
a dental coping for removable engagement with a dental component extending from gingival tissue having:
a body having a coronally extending frusto-conical exterior surface, an interior recess, a closed coronal end and an open apical end, wherein the interior recess comprises a frusto-conical inner surface extending coronally from the apical end and a substantially flat coronal surface at the closed coronal end of the body; and
an aligning rib extending from the coronal surface and the inner surface of the interior recess, wherein the aligning rib extends apically from the coronal surface and inwardly from a coronal portion of the inner surface, and wherein the aligning rib is designed to engage a corresponding groove formed in a coronal portion of the dental component to enable seating of the coping on the dental component in an aligned orientation and to prevent substantially rotation of the coping with respect to the component,
wherein the aligning rib is sufficiently rigid to prevent seating of the coping on the dental component in an orientation other than the aligned orientation and to provide a visual indication when the coping is not seated on the dental component in the aligned orientation; and
a dental component comprising a groove for removably engaging the aligning rib of the coping.

8. The dental assembly of claim 7, wherein the coping further comprises a flat alignment surface formed on the inner surface of the interior recess.

9. The dental assembly of claim 8, wherein the aligning rib is provided substantially opposite the flat alignment surface on the inner surface of the inner recess.

10. The dental assembly of claim 8, wherein the dental component further comprises a flat surface for contacting the flat alignment surface of the impression cap.

11. The dental assembly of claim 7, wherein the dental coping further comprises at least one additional aligning rib extending from the coronal surface and the inner surface of the interior recess and designed to engage a corresponding additional groove formed in the coronal portion of the dental component to enable seating of the coping on the dental component in the aligned orientation.

12. The dental assembly of claim 7, wherein the dental component comprising a plurality of grooves, each designed to removably engage the aligning rib of the coping.

13. The dental assembly of claim 7, wherein the coping further includes an engagement feature that enables the coping to snap fit onto the dental component.

14. The dental assembly of claim 7, wherein the dental component includes an abutment.

15. The dental assembly of claim 7, wherein the dental component includes an implant.

16. The dental assembly of claim 7, wherein the dental component is an analog.
